(19) United States
(12) Patent Application Publication
(10) Pub. No.: US 2005/0207676 A1
(43) Pub. Date: Sep. 22, 2005

(54) METHOD FOR DECIMATING IMAGE DATA FILTERED BY A BAYER PATTERN COLOR FILTER ARRAY

(76) Inventors: Wen-Kuo Lin, Taipei City (TW); Kuo-Ping HSU, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,622

(22) Filed: Mar. 16, 2004

(51) Int. Cl. G06K 9/00; G06K 9/32

(52) U.S. Cl. 382/299; 382/162

(57) ABSTRACT

A method for decimating a first image data filtered by a Bayer pattern color filter array. The first image data includes a plurality of patterns arrayed in a matrix. Each pattern includes a first color pixel. The method includes providing first color pixel weighting values of the plurality of patterns of the first image data, and summing up the first color pixel weighting values to generate a first color pixel of a second image data decimated from the first image data.

### BACKGROUND OF INVENTION

1. Field of the Invention

The present invention relates to a method for decimating an image data, and more particularly, to a method for decimating an image data filtered by a Bayer pattern color filter array.

2. Description of the Prior Art

Bayer pattern color filter array is widely applied to image sensors of image-capturing devices for filtering color information of light emitted from the capturing object.

Please refer to FIG. 1. FIG. 1 is a color filter arrangement diagram of a Bayer pattern color filter array 10. The Bayer pattern color filter array 10 includes a plurality of patterns 12 arrayed in a matrix. Each pattern 12 includes three kinds of color filters arrayed in a 2×2 matrix. The three kinds of color filters are a red color filter, a blue color I filter, and a green color filter. As shown in FIG. 1, “r” symbolizes the red color filter, “gg” symbolizes the green color filter, and “b” symbolizes the blue color filter. There are one red color filter, one blue color filter, and two green color filters in each pattern 12 because it is based on the fact that human visual system is more sensitive to the green color information than to the red and blue information. Please refer to FIG. 2. FIG. 2 is a diagram of four possible organizations of the pattern 12. There are four possible organizations 12a, 12b, 12c, 12d of the pattern 12 according to different color arrangements. Basically the two green color filters are positioned in a diagonal direction instead of being positioned closely. The red color filter and the blue color filter are also positioned in a diagonal direction.

Please refer to FIG. 3. FIG. 3 is a color arrangement diagram of a first image data 14 filtered by the Bayer pattern color filter array 10. The first image data 14 is a 4×4 pattern 12 matrix and is also a 8×8 pixel matrix. The first image data includes a first area 18, a second area 20, a third area 22, and a fourth area 24. Please refer to FIG. 4. FIG. 4 is a color arrangement diagram of decimating the first image data 14 to a second image data 26 conventionally. The decimation method is keeping the upper-left patterns 12 of the first area 18, the second area 20, the third area 22, and the fourth area 24 and deleting other pattern 12. So the second image data 26 is composed of the four patterns 12 sampled from the four areas, and the size of the second image data 26 is one quarter of the size of the first image 14. The small letter “r” shown in FIG. 3 and FIG. 4 symbolizes the red pixel datum of the first image data 14. The small letter “g” shown in FIG. 3 and FIG. 4 symbolizes the green pixel datum of the first image data 14. The small letter “b” shown in FIG. 3 and FIG. 4 symbolizes the blue pixel datum of the first image data 14. The capital letter “R” shown in FIG. 3 and FIG. 4 symbolizes the red pixel datum of the second image data 26. The capital letter “G” shown in FIG. 3 and FIG. 4 symbolizes the green pixel datum of the second image data 26. The capital letter “B” shown in FIG. 3 and FIG. 4 symbolizes the blue pixel datum of the second image data 26. The upper-left pattern 12 of the second image data 26 has the following relation with pixels of the first area 18 of the first image data 14: G00=g00, R01=r01, B10=b10, G11=g11; Similarly the upper-right pattern 12 of the second image data 26 has the following relation with pixels of the second area 20 of the first image data 14: G02=g04, R03=r05, B12=b14, G13=g15; The lower-left pattern 12 of the second image data 26 has the following relation with pixels of the third area 22 of the first image data 14: G02=g04, R03=r05, B12=b14, G13=g15; The lower-right pattern 12 of the second image data 26 has the following relation with pixels of the fourth area 24 of the first image data 14: G22=g44, R23=r45, B32=b54, G33=g55.

Please refer to FIG. 5. FIG. 5 is a color arrangement diagram of decimating the first image data 14 to a third image data 28 conventionally. The decimation method is keeping the four pixels g00, r03, b30, g33 in four corners of the first area 18, the four pixels g04, r07, b34, g37 in four corners of the second area 20, the four pixels g40, r43, b70, g73 in four corners of the third area 22, and the four pixels g44, r47, b74, g77 in four corners of the fourth area 24 and deleting other pixels. So the third image data 28 is composed of the sixteen pixels sampled from the four corners of the four areas. That is, the upper-left patterns 12 of the third image data 28 is composed of the pixels g00, r03, b30, g33 in four corners of the first area 18 of the first image data 14, wherein G00=g00, R01=r03, B10=b30, G11=g33. Similarly the other patterns 12 of the third image data 28 are composed of the pixels g04, r07, b34, g37 of the second area 20 of the first image data 14, the pixels g40, r43, b70, g73 of the third area 22, and the pixels g44, r47, b74, g77 of the fourth area 24 individually.

These two afore mentioned Bayer Pattern decimation processes are simple and widely realized in the hardware implementation, mostly integrated with the image sensor circuits. However these two decimation processes can cause staircase discontinuity on titled straight lines and titled straight object edges. Therefore, the visual quality on the final decimated results is degraded.

### SUMMARY OF INVENTION

It is therefore a primary objective of the claimed invention to provide a method for decimating an image data filtered by a Bayer pattern color filter array for solving the above-mentioned problem.

According to the claimed invention, a method for decimating a first image data filtered by a Bayer pattern color filter array is proposed. The first image data includes a plurality of patterns arranged in an array, and each pattern includes a first color pixel. The method includes providing first color pixel weighting values of the plurality of patterns of the first image data, and summing up the first color pixel weighting values to generate a first color pixel of a second image data decimated from the first image data.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a color filter arrangement diagram of a Bayer pattern color filter array.

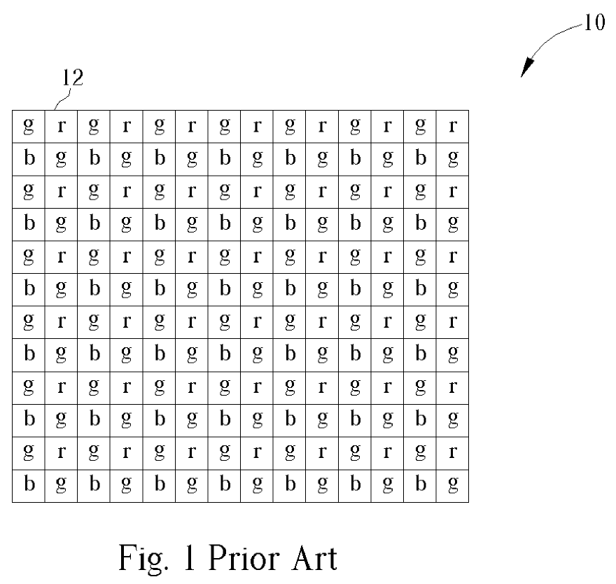

FIG. 2 is a diagram of four possible organizations of the pattern.

FIG. 3 is a color arrangement diagram of a first image data filtered by the Bayer pattern color filter array.

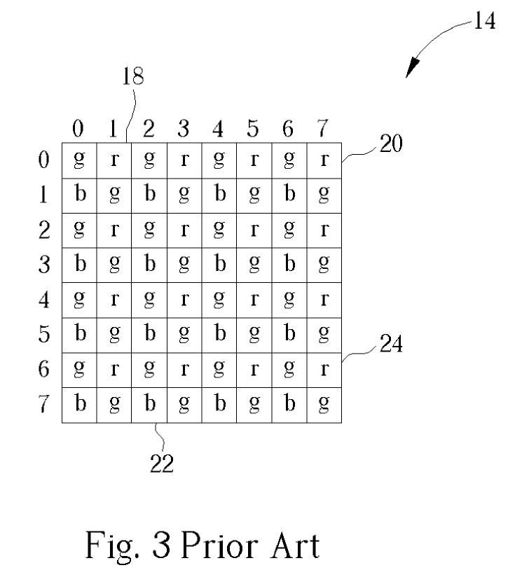

FIG. 4 is a color arrangement diagram of decimating the first image data to a second image data conventionally.

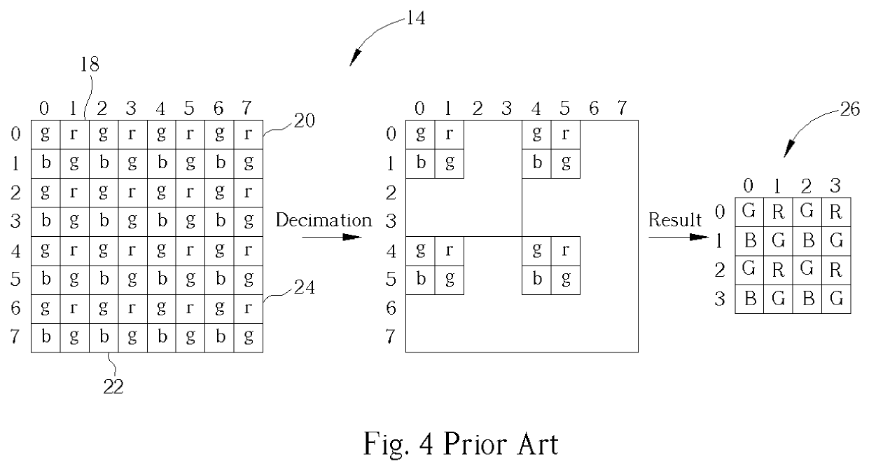

FIG. 5 is a color arrangement diagram of decimating the first image data 14 to a third image data conventionally.

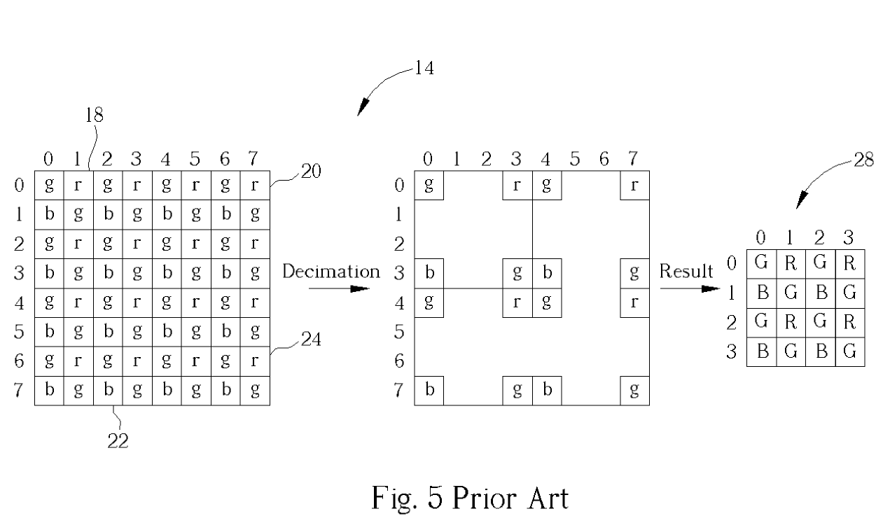

FIG. 6 is a flowchart of decimating the first image data filtered by the Bayer pattern color filter array according to the present invention.

FIG. 7 is a color arrangement diagram of decimating the first image data to the fourth image data according to a first embodiment of the present invention.

FIG. 8 is a color arrangement diagram of a fifth image data according to a second embodiment of the present invention.

FIG. 9 is a color arrangement diagram of decimating the fifth image data to a sixth image data according to the second embodiment of the present invention.

FIG. 10 is a color arrangement diagram of decimating the first image data to a seventh image data according to a third embodiment of the present invention.

FIG. 11 is a color arrangement diagram of decimating the fifth image data to an eighth image data according to a fourth embodiment of the present invention.

### DETAILED DESCRIPTION

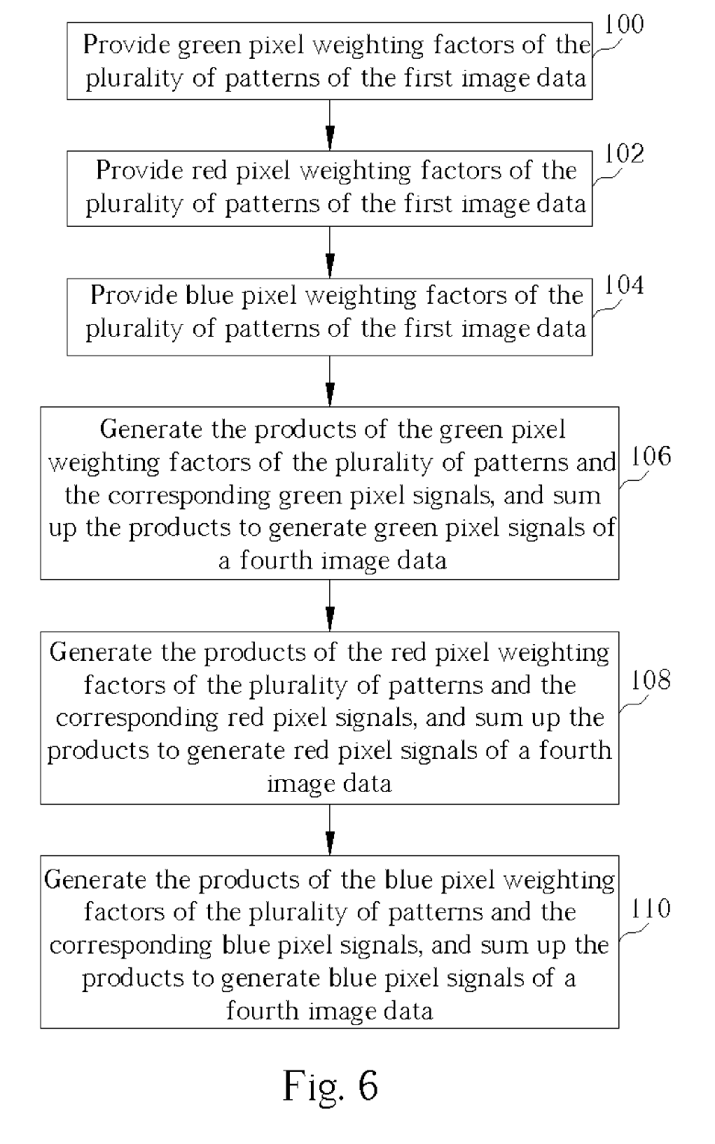

Please refer to FIG. 6. FIG. 6 is a flowchart of decimating the first image data 14 filtered by the Bayer pattern color filter array 10 according to the present invention. The method includes:

Step 100: Provide green pixel weighting factors of the plurality of patterns 12 of the first image data 14;

Step 102: Provide red pixel weighting factors of the plurality of patterns 12 of the first image data 14;

Step 104: Provide blue pixel weighting factors of the plurality of patterns 12 of the first image data 14;

Step 106: Generate the products of the green pixel weighting factors of the plurality of patterns 12 and the corresponding green pixel signals, and sum up the products to generate green pixel signals of a fourth image data 30 decimated from the first image data 14;

Step 108: Generate the products of the red pixel weighting factors of the plurality of patterns 12 and the corresponding red pixel signals, and sum up the products to generate red pixel signals of a fourth image data 30 decimated from the first image data 14; and

Step 110: Generate the products of the blue pixel weighting factors of the plurality of patterns 12 and the corresponding blue pixel signals, and sum up the products to generate blue pixel signals of a fourth image data 30 decimated from the first image data 14.

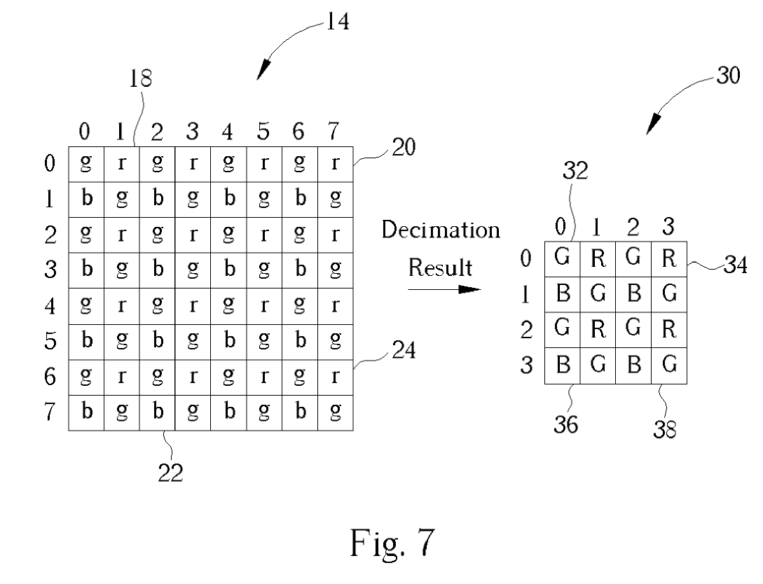

Please refer to FIG. 7. FIG. 7 is a color arrangement diagram of decimating the first image data 14 to the fourth image data 30 according to a first embodiment of the present invention. The small letters “r, g, b” shown in FIG. 7 symbolize the red, green, blue pixel data of the first image data 14. The capital letters “R, G, B” shown in FIG. 7 symbolize the red, green, blue pixel data of the fourth image data 30. A first pattern 32 in the upper-left corner of the fourth image data 30 can be decimated from the pixels in the first area 18 of the first image data 14. A second pattern 34 in the upper-right corner of the fourth image data 30 can be decimated from the pixels in the second area 20 of the first image data 14. A third pattern 36 in the lower-left corner of the fourth image data 30 can be decimated from the pixels in the third area 22 of the first image data 14. A fourth pattern 38 in the lower-right corner of the fourth image data 30 can be decimated from the pixels in the fourth area 24 of the first image data 14.

The process about decimating the pixels in the first area 18 of the first image data 14 to the first pattern 32 in the upper-left corner of the fourth image data 30 is described as follows. First the green pixel weighting factors i00, i02, i11, i20, i22 corresponding to the green pixels g00, g02, g11, g20, g22 in the first area 18 of the first image data 14 are provided. The green pixel G00 of the first pattern 32 of the fourth image data 30 can be generated from the following relation: G00=i00*g00+i02*g02+i11*g11+i20*g20+i22*g22. The sum of the five green pixel weighting factors i00, i02, i11, i20, i22 can be 1 so that the luminance of the green pixel G00 can be equal to the luminance of the green pixels of the first image data 14 approximately. The positions of the green pixels g00, g02, g11, g20, g22 in the first image data 14 are corresponding to the position of the green pixel G00 in the fourth image data 30. So the decimation method according to the present invention can keep the luminance conservation and reduce the distortion of the spatial distribution effectively.

Using the same logic, the red pixel weighting factors j01, j03, j21, j23 corresponding to the red pixels r01, r03, r21, r23 in the first area 18 of the first image data 14 are provided. The red pixel R01 of the first pattern 32 of the fourth image data 30 can be generated from the following relation: R01=j01*r01+j03*r03+j21*r21+j23*r23. The sum of the four red pixel weighting factors j01, j03, j21, and j23 can be 1. The blue pixel weighting factors k10, k12, k30, k32 corresponding to the blue pixels b10, b12, b30, b32 in the first area 18 of the first image data 14 are provided. The blue pixel B10 of the first pattern 32 of the fourth image data 30 can be generated from the following relation: B10=k10*b10+k12*b12+k30*b30+k32*b32. The sum of the four blue pixel weighting factors j01, j03, j21, and j23 can be 1. The green pixel weighting factors m11, m13, m22, m31, m33 corresponding to the green pixels g11, g13, g22, g31, g33 in the first area 18 of the first image data 14 are provided. The green pixel G11 of the first pattern 32 of the fourth image data 30 can be generated from the following relation: G11=m11*g11+m13*g13+m22*g22+m31*g31+m33*g3 3. The sum of the five green pixel weighting factors m11, m13, m22, m31, and m33 can be 1. In conclusion, the first pattern 32 of the fourth image data 30 is composed of the pixels G00, R01, B10, G11. Using the same logic, the second pattern 34, the third pattern 36, and the fourth pattern 38 also can be generated by the above-mentioned method.

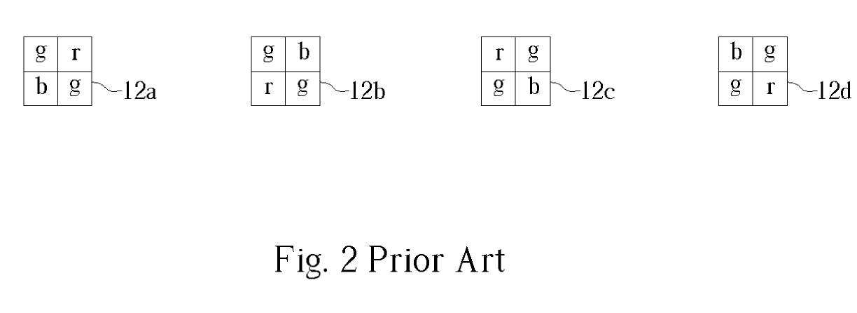

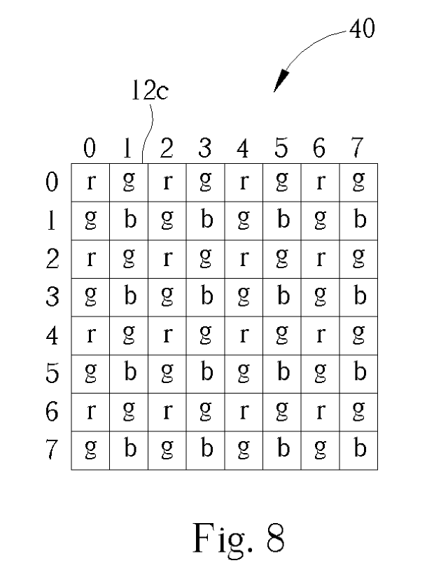

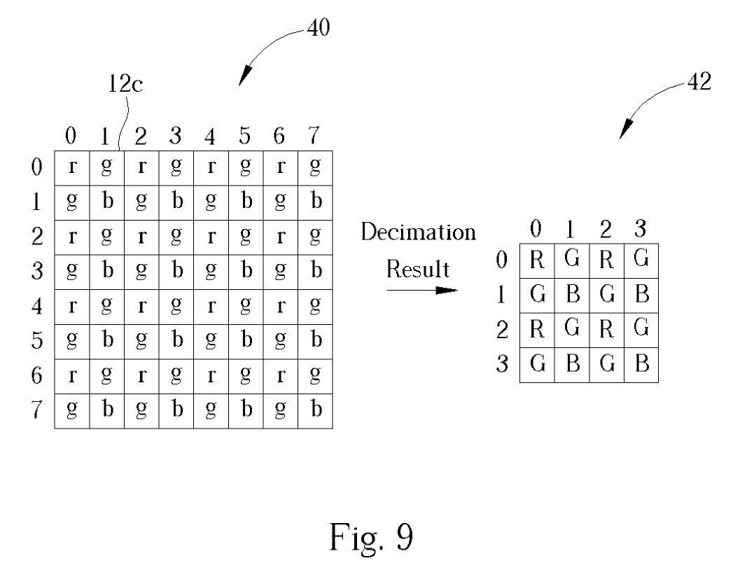

If the type of the pattern 12 of the first image data 14 is not the type of the pattern 12a shown in FIG. 2 and belongs to the types of the pattern 12b, 12c, or 12d, the above-mentioned decimation method also can be used. For example, please refer to FIG. 8. FIG. 8 is a color arrangement diagram of a fifth image data 40 according to a second embodiment of the present invention. The fifth image data 40 is composed of the pattern 12c. FIG. 9 is a color arrangement diagram of decimating the fifth image data 40 to a sixth image data 42 according to the second embodiment of the present invention. Using the same decimation method, the pixels of the sixth image data 42 has the following relation with the pixels of the fifth image data 40:
R00=i00*r00+i02*r02+i20*r20+i22*r22;
G01=j01*g01+j03*g03+j12*g12+j21*g21+j23*g23;
G10=k10*g10+k12*g12+k21*g21+k30*g30+k32*g32;
B11=m11*b11+m13*b13+m31*b31+m33*b33;

The red pixel weighting factors i00, i02, i20, i22 are corresponding to the red pixels r00, r02, r20, r22 of the fifth image data 40 and to generate the red pixel R00 of the sixth image data 42. The green pixel weighting factors j01, j03, j12, j21, j23 are corresponding to the green pixels g01, g03, g12, g21, g23 of the fifth image data 40.

The green pixel weighting factors k10, k12, k21, k30, k32 are corresponding to the green pixels g10, g12, g21, g30, g32 of the fifth image data 40. And the blue pixel weighting factors m11, m13, m31, m33 are corresponding to the blue pixels b11, b13, b31, b33 of the fifth image data 40. The sum of the four red pixel weighting factors i00, i02, i20, and i22 can be 1. Similarly, the sum of j01, j03, j12, j21, j23, the sum of k10, k12, k21, k30, and the sum of m11, m13, m31, and m33 can be 1. The other pixels of the sixth image data 42 also can be generated by the above-mentioned decimation method.

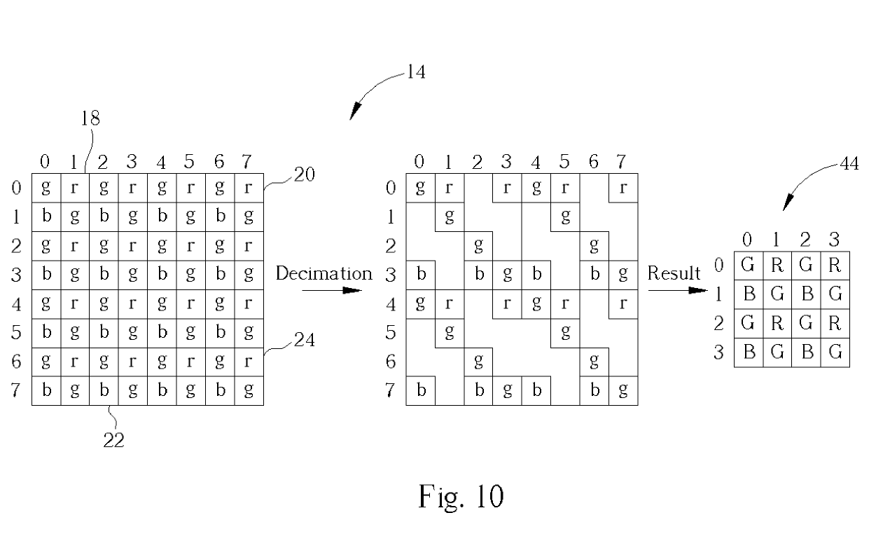

If the decimation complexity and cost are the major concern, the above-mentioned decimation method can be simplified by selecting certain values for weighting factors. Please refer to FIG. 10. FIG. 10 is a color arrangement diagram of decimating the first image data 14 to a seventh image data 44 according to a third embodiment of the present invention. The pixels of the seven image data 44 has the following relation with the pixels of the first image data 14:
G00=i00*g00+i11*g11;
R01=j01*r01+j03*r03;
B10=k30*b30+k32*b32;
G11=m22*g22+m33*g33;

The green pixel weighting factors i00, i11 are corresponding to the green pixels g00, g11 of the first image data 14 and to generate the green pixel G00 of the seventh image data 44. The red pixel weighting factors j01, j03 are corresponding to the red pixels r01, r03 of the first image data 14. The blue pixel weighting factors k30, k32 are corresponding to the blue pixels b30, b32 of the first image data 14. And the green pixel weighting factors m22, m33 are corresponding to the green pixels g22, g33 of the first image data 14. The other pixels of the seventh image data 44 also can be generated by the same decimation method. In the third embodiment of the present invention the weighting factors i02, i20, i22, j21, j23, k10, k12, m11, m13, m31 of the first embodiment are set to 0. That is, the pixels g02, g20, g22, r21, r23, b10, b12, g11, g13, g31 of the first image data 14 are not sampled in the third embodiment. So the data operating and buffer size in the third embodiment is about one half of the one in the first embodiment. As a result, this embodiment provides a low complexity and low cost implementation for the present invention. Furthermore pixels are sampled in each row and column of the original first image data 14 so that staircase discontinuity on titled straight lines and titled straight object edges can be eliminated and the visual quality on the final decimated results is upgraded.

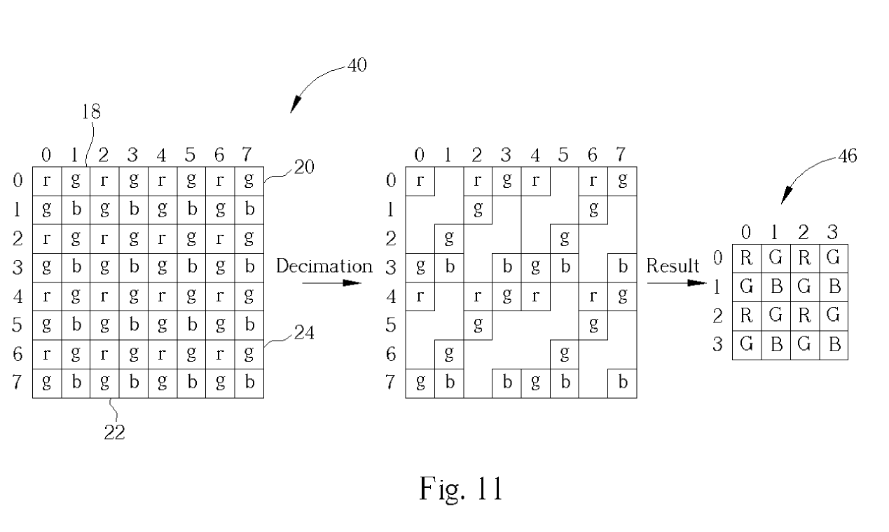

If the type of the pattern 12 of the first image data 14 is not the type of the pattern 12a shown in FIG. 2 and belongs to the types of the pattern 12b, 12c, or 12d, the above-mentioned decimation method in the third embodiment also can be used. For example, please refer to FIG. 11. FIG. 11 is a color arrangement diagram of decimating the fifth image data 40 to an eighth image data 46 according to a fourth embodiment of the present invention.

Using the same decimation method, the pixels of the eighth image data 46 has the following relation with the pixels of the fifth image data 40:
R00=i00*r00+i02*r02;
G01=j03*g03+j12*g12;
G10=k21*g21+k30*g30;
B11=m31*b31+m33*b33;

The red pixel weighting factors i00, i02 are corresponding to the red pixels r00, r02 of the fifth image data 40 and to generate the red pixel R00 of the eighth image data 46. The green pixel weighting factors j03, j12 are corresponding to the green pixels g03, g12 of the fifth image data 40. The green pixel weighting factors k21, k30 are corresponding to the green pixels g21, g30 of the fifth image data 40. And the blue pixel weighting factors m31, m33 are corresponding to the blue pixels b31, b33 of the fifth image data 40. The other pixels of the eighth image data 46 also can be generated by the same decimation method.

In conclusion, the method according to the present invention is for weighting pixels of an image data filtered by a Bayer pattern color filter array and then summing up the weighting values to generate a decimated data. All kinds of methods for setting weighting factors are all within the scope of the present invention.

In contrast to the prior art, the decimation method according to the present invention is for weighting pixels of an original image data and then summing up the weighting values to generate a decimated data. So the staircase discontinuity on titled straight lines and titled straight object edges can be eliminated and the visual quality on the final decimated results is upgraded.

Those skilled in the art will readily observe that numerous modifications and alterations of the method may be made while retaining the teachings of the invention. Accordingly, the above disclosure should be construed as limited only by the metes and bounds of the appended claims.

1. A method for decimating a first image data filtered by a Bayer pattern color filter array, the first image data comprising a plurality of patterns arranged in an array, each pattern comprising a first color pixel, the method comprising:
providing first color pixel weighting values of the plurality of patterns of the first image data; and
summing up the first color pixel weighting values to generate a first color pixel of a second image data decimated from the first image data.

2. The method of claim 1 further comprising providing a plurality of first color pixel weighting factors, wherein the first color pixel weighting value is the product of the first color pixel weighting factor and the corresponding first color pixel signal of the first image data.

3. The method of claim 2 wherein the sum of the plurality of first color pixel weighting factors is 1.

4. The method of claim 1 wherein the first color pixel is a red pixel.

5. The method of claim 1 wherein the first color pixel is a green pixel.

6. The method of claim 1 wherein the first color pixel is a blue pixel.

7. The method of claim 1 wherein each pattern comprises a red pixel, two green pixels, and a blue pixel.
